(19) United States
(12) Patent Application Publication
(10) Pub. No.: US 2026/0270464 A1
(43) Pub. Date: Sep. 10, 2026

(54) Methods and Apparatus for Video Coding Using Non-Adjacent Motion Vector Prediction

(71) Applicant: MEDIATEK INC., Hsinchu City (TW)

(72) Inventors: Chen-Yen LAI, Hsinchu City (TW); Chih-Wei HSU, Hsinchu City (TW); Tzu-Der CHUANG, Hsinchu City (TW); Ching-Yeh CHEN, Hsinchu City (TW); Yu-Wen HUANG, Hsinchu City (TW)

(21) Appl. No.: 18/876,396

(22) PCT Filed: May 24, 2023
(86) PCT No.: PCT/CN2023/095965

§ 371 Date: Dec. 18, 2024

Related U.S. Application Data
(60) Provisional application No. 63/354,804, filed on Jun. 23, 2022.

(51) Int. Cl. H04N 19/52; H04N 19/105; H04N 19/139; H04N 19/167; H04N 19/176

(52) U.S. Cl. CPC H04N 19/52; H04N 19/105; H04N 19/139; H04N 19/167; H04N 19/176

(57) ABSTRACT

Methods for reducing buffer requirement associated with non-adjacent MVP (Motion Vector Prediction). According to this method, one or more first non-adjacent MVP (Motion Vector Prediction) candidates are derived based on previous motion information in a first region comprising a current CTU (coding tree unit) of the current block, wherein the first region is limited to be within one or more pre-define distances in a vertical direction, a horizontal direction or both from the current CTU. A merge candidate list comprising said one or more first non-adjacent MVP candidates is generated. The merge list is then used to encode or decode motion information.

### CROSS REFERENCE TO RELATED APPLICATIONS

The present invention is a non-Provisional Application of and claims priority to U.S. Provisional Patent Application No. 63/354,804, filed on Jun. 23, 2022. The U.S. Provisional Patent Application is hereby incorporated by reference in its entirety.

### FIELD OF THE INVENTION

The present invention relates to motion Vector Prediction (MVP) using the merge candidate list comprising one or more non-adjacent MVP candidates in a video coding system.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In the present invention, methods and apparatus for simplifying non-adjacent MVP are disclosed.

### BRIEF SUMMARY OF THE INVENTION

A method and apparatus for video coding using NAMVP (Non-Adjacent Motion Vector Prediction) are disclosed. According to the method at the decoder side, coded data associated with a current block to be decoded are received. One or more first non-adjacent MVP candidates are derived based on previous motion information in a first region comprising a current CTU (coding tree unit) of the current block, wherein the first region is limited to be within one or more pre-define distances in a vertical direction, a horizontal direction or both from the current CTU. A merge candidate list comprising said one or more first non-adjacent MVP candidates is generated. Current motion information for the current block is derived from the coded data according to the merge candidate list.

In one embodiment, the first region comprises a current CTU row of the current block or left M CTUs of the current block, and wherein M is a positive integer. In one embodiment, the first region further comprises N above CTU rows, and wherein N is a positive integer. In one embodiment, motion information for the current CTU row is stored in an N×N grid.

In one embodiment, one or more second non-adjacent MVP candidates at one or more to-be referenced positions in a second region outside the first region are selected and included in the merge candidate list, and wherein said one or more to-be referenced positions are mapped to one or more pre-defined positions. In one embodiment, the first region comprises a current CTU row of the current block and above-first CTU row of the current block. Furthermore, the second region comprises an above-second CTU row and an above-third CTU row.

In one example, a target pre-defined position associated with a corresponding to-be referenced position is located at one line above the above-first CTU row and at a corresponding horizontal position. In another example, a target pre-defined position associated with a corresponding to-be referenced position is located at a bottom line of respective CTU row associated with the corresponding to-be referenced position and at a corresponding horizontal position. In yet another example, a target pre-defined position associated with a corresponding to-be referenced position is located at a bottom line or a centre line of respective CTU row associated with the corresponding to-be referenced position, depending on the corresponding to-be referenced position, and at a corresponding horizontal position. In yet another example, a target pre-defined position associated with a corresponding to-be referenced position is located at a bottom line of respective CTU row or one CTU row above the respective CTU row associated with the corresponding to-be referenced position, depending on the corresponding to-be referenced position, and at a corresponding horizontal position.

In one embodiment, motion information for the first region is stored in 4×4 grid and the motion information outside the first region is stored in 16×16 grid.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an exemplary pattern of the non-adjacent spatial merge candidates.

FIG. 3 illustrates an example to map motion information for the to-be referenced positions in a non-available region to pre-defined positions, where the pre-defined positions are located at one line above the above-first CTU row.

FIG. 4 illustrates an example to map motion information for the to-be referenced positions in a non-available region to pre-defined positions, where the pre-defined positions are located at the bottom line of respective CTU rows.

FIG. 5 illustrates an example to map motion information for the to-be referenced positions in a non-available region to pre-defined positions, where the pre-defined positions are located at the bottom line or the centre line of respective CTU rows.

FIG. 6 illustrates an example to map motion information for the to-be referenced positions in a non-available region to pre-defined positions, where the pre-defined positions are located at the bottom line of respective CTU rows or one CTU row above the respective CTU rows.

FIG. 7 illustrates a flowchart of an exemplary video decoding system that limits the region for deriving non-adjacent MVP candidates according to one embodiment of the present invention.

FIG. 8 illustrates a flowchart of an exemplary video encoding system that limits the region for deriving non-adjacent MVP candidates according to one embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

During the development of the VVC standard, a coding tool referred as Non-Adjacent Motion Vector Prediction (NAMVP) has been proposed in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399). According to the NAMVP technique, the non-adjacent spatial merge candidates are inserted after the TMVP (i.e., the temporal MVP) in the regular merge candidate list. The pattern of spatial merge candidates is shown in FIG. 2. The distances between non-adjacent spatial candidates and current coding block are based on the width and height of current coding block. In FIG. 2, each small square corresponds to a NAMVP candidate and the candidates are ordered (as shown by the number inside the square) according to the distance. The line buffer restriction is not applied. In other words, the NAMVP candidates far away from a current block may have to be stored that may require a large buffer.

The merge mode is an efficient coding tool to code motion information. The merge mode takes advantage of spatial and temporal correlation in motion information among picture frames and generates a merge list at both the encoder side and the decoder side. At the encoder side, when the current motion information is coded, it compares the current motion information with the merge list. If the current motion information matches a candidate in the merge list, an index can be signalled to indicate the corresponding candidate in the merge list. Since the merge list usually contains a small number of candidates, the candidate index can be more efficiently coded than the motion information itself. At the decoder side, a candidate index is parsed if the block is coded in the merge mode. The motion information can be recovered based on the parsed candidate index and the merge list.

In order to reduce the storage buffer of motion information for non-adjacent spatial merge candidates, some methods are proposed as follows.

### Method 1: Storing Only one Motion Information Within a Pre-Defined Region

According to this method, only one motion information in a pre-defined region will be stored. For example, for each 16×16 region, only the motion information in the first CU is stored for the non-adjacent spatial candidate to reference. In another example, for each 16×16 region, only the motion information in the last CU is stored for the non-adjacent spatial candidate to reference. In one embodiment, to further preserve the coding efficiency of non-adjacent spatial merge candidates, the previous mentioned technology (i.e., only one motion information in a pre-defined region will be stored) is only used for the region excluding current CTU or excluding current CTU row.

### Method 2: Limiting the Available Region of Non-Adjacent Spatial Merge Candidate

Method 2 is proposed to further reduce the bandwidth for supporting the non-adjacent spatial merge candidate. In one embodiment, only the motion information in the current CTU can be referenced by the non-adjacent spatial merge candidate. In another embodiment, only the motion information in the current CTU or left M CTUs can be referenced by the non-adjacent spatial merge candidate. M can be any integer larger than 0. In another embodiment, only the motion information in the current CTU row can be referenced by the non-adjacent spatial merge candidate. In one embodiment, only the to-be referenced position within the current CTU row or above N CTU rows can be referenced. N can be any integer larger than 0.

In another embodiment, the motion information in the current CTU, the current CTU row, the current CTU row+above N CTU rows, the current CTU+left M CTUs, or the current CTU+above N CTU rows+left M CTUs can be referenced without limits. Furthermore, the motion information in other regions can only be referenced by a larger pre-defined unit. For example, the motion information in the current CTU row is stored within a 4×4 grid or any other N×N grid (e.g. N=4, 8, 16, 32, or any other integer), and for other motion information outside the current CTU row is stored within a 16×16 grid. In other words, one 16×16 region only needs to store one motion information, so the to-be referenced position shall be rounded to the 16×16 grid, or changed to the nearest position of 16×16 grid.

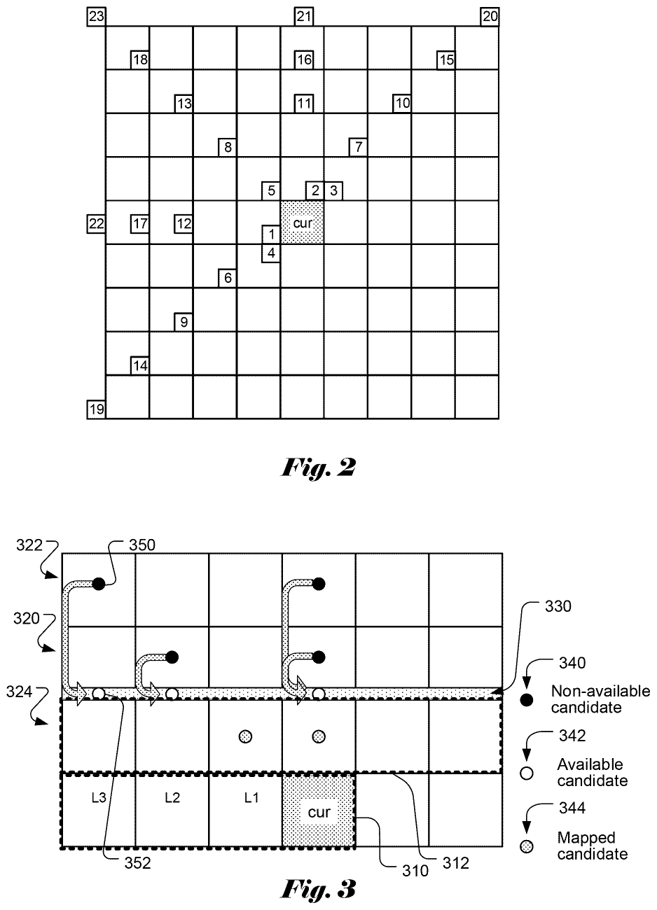

In another embodiment, the motion information in the current CTU row, or the current CTU row+M CTU rows can be referenced without limits, and for the to-be referenced positions in the above CTU row, the positions will be mapped to one line above of current CTU, or the current CTU row+M CTU rows for referencing. This design can preserve most of the coding efficiency and doesn't increase buffer by much for storing the motion information of above CTU rows. For example, the motion information in the current CTU row (310) and the first CTU row above (312) can be referenced without limits; and for the to-be referenced positions in the above-second (320), above-third (322), above-fourth CTU row, and so on, the positions will be mapped to one line (330) above the above-first CTU row before referring (as shown in FIG. 3). In FIG. 3, A dark circle indicates a non-available candidate 340, an empty circle indicates an available candidate 342 and a dot-filled circle indicates a non-available candidate 344. For example, the non-available candidate 350 in the above-second (320) CTU row is mapped to an available candidate 352 in one line (330) above the above-first CTU row (324).

In the above example, the region that can be referenced without limits is close to the current CTU (e.g. the current CTU row or the above-first CTU row). However, the region according to the present invention is not limited to the exemplary region shown above. The region can be larger or smaller than the example shown above. In general, the region can be limited to be within one or more pre-define distances in a vertical direction, a horizontal direction or both from the current CTU. In the above example, the region is limited to 1 CTU height in the above vertical direction, which can be extended to 2 or 3 CTU heights if desired. In the case that left M CTUs are used, the limit is M CTU width for the current CTU row. The horizontal position of a to-be referenced position and the horizontal position of a mapped pre-defined position can be the same (e.g. position 350 and position 352 in the same horizontal position). However, other horizontal position may also be used.

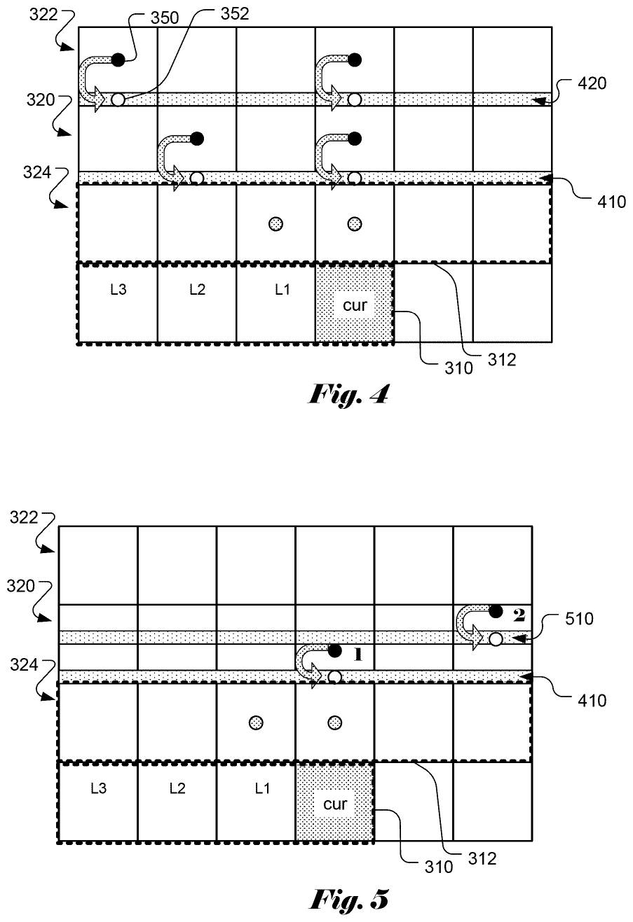

In another embodiment, the motion information in the current CTU row, or the current CTU row+M CTU rows can be referenced without limits. Furthermore, for the to-be referenced positions in the above CTU row, the positions will be mapped to the last line of the corresponding CTU row for referencing. For example, as shown in FIG. 4, the motion information in the current CTU row (310) and the first CTU row (312) above can be referenced without limits, and for the to-be referenced positions in the above-second CTU row (320), the positions will be mapped to the bottom line (410) of the above-second CTU row (320) before referring. For the to-be referenced positions in above third CTU row (322), the positions will be mapped to the bottom line (420) of the above-third CTU row (322) before referring. The legend for the candidate types (i.e., 340, 342 and 344) of FIG. 4 is the same as that in FIG. 3.

In another embodiment, the motion information in the current CTU row, or the current CTU row+M CTU rows can be referenced without limits, and for the to-be referenced positions in above CTU row, the positions will be mapped to the last line or bottom line or centre line of the corresponding CTU row for referencing depending on the position of the to-be referenced motion information. For example, as shown in FIG. 5, the motion information in the current CTU row (310) and the above-first CTU row (312) can be referenced without limits, and for the to-be referenced position 1 in above-second CTU row (320), the positions will be mapped to the bottom line (410) of the above-second CTU row before referring. However, for the to-be referenced position 2 in above-second CTU row, the positions will be mapped to the centre line (510) of the above-second CTU row (320) before referring since it is closer to the centre line (510) compared with bottom line (410). The legend for the candidate types (i.e., 340, 342 and 344) of FIG. 5 is the

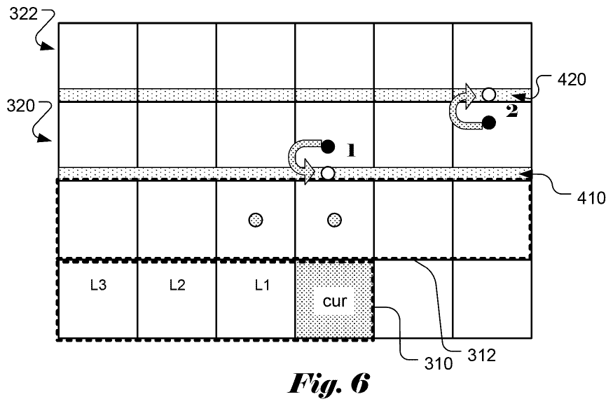

In another embodiment, the motion information in the current CTU row, or the current CTU row+M CTU rows can be referenced without limits, and for the to-be referenced positions in the above CTU row, the positions will be mapped to the last line or bottom line of the corresponding CTU row for referencing depending on the position of the to-be referenced motion information. For example, as shown in FIG. 6, the motion information in the current CTU row (310) and the above-first CTU row (312) can be referenced without limits, and for the to-be referenced position 1 in the above-second CTU row (320), the positions will be mapped to the bottom line (410) of the above-second CTU row (320) before referring. However, for the to-be referenced position 2 in the above-second CTU row (320), the positions will be mapped to the bottom line (420) of the above-third CTU row (322) before referring since it is closer to the bottom line (420) of the above-third CTU row compared with bottom line (410) of the above-second CTU row as shown in FIG. 6. The legend for the candidate types (i.e., 340, 342 and 344) is the same as that in FIG. 3.

In another embodiment, the motion information in the current CTU, or the current CTU+N left CTU can be referenced without limits, and for the left CTUs, the to-be referenced positions will be mapped to the very right line closest to the current CTU, or the current CTU+N left CTU. For example, the motion information in the current CTU and first left CTU can be referenced without limits, and if the to-be referenced positions are in the second left CTU, the positions will be mapped to one line left to the first left CTU before referring. If the to-be referenced positions are in the third left CTU, the positions will be mapped to one line left to first left CTU before referring. For example, the motion information in the current CTU and the first left CTU can be referenced without limits, and if the to-be referenced positions are in the second left CTU, the positions will be mapped to the very right line of the second left CTU before referring. If the to-be referenced positions are in the third left CTU, the positions will be mapped to the very right line to the third left CTU before referring.

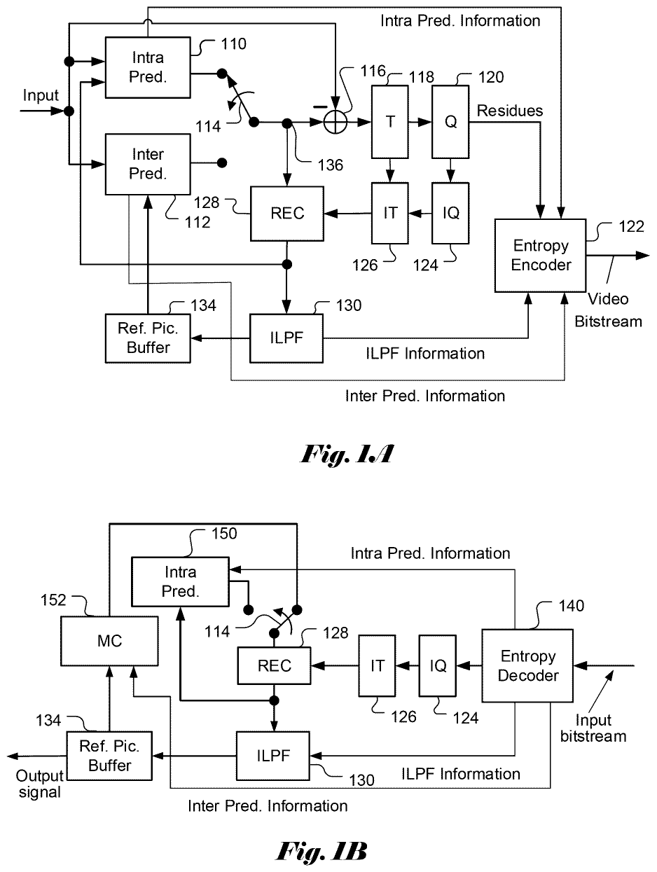

Any of the foregoing NAMVP methods can be implemented in encoders and/or decoders. For example, any of the proposed methods can be implemented in an inter prediction module in the encoder (e.g. Inter Pred. 112 of FIG. 1A) or the decoder (e.g. MC 152 of FIG. 1B). However, the encoder or the decoder may also use additional processing units to implement the required processing. Alternatively, any of the proposed methods can be implemented as a circuit coupled to the inter/intra/prediction module of the encoder and/or the inter/intra/prediction module of the decoder, so as to provide the information needed by the inter/intra/prediction module. Furthermore, signalling related to the proposed methods may be implemented using Entropy Encoder 122 in the encoder or Entropy Decoder 140 in the decoder.

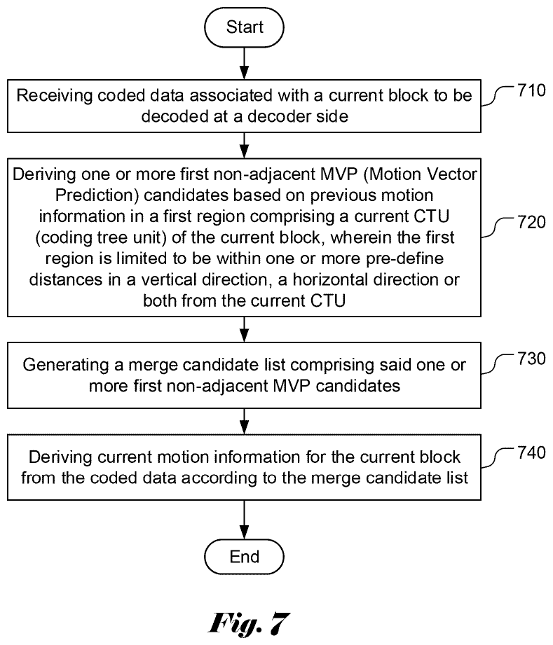

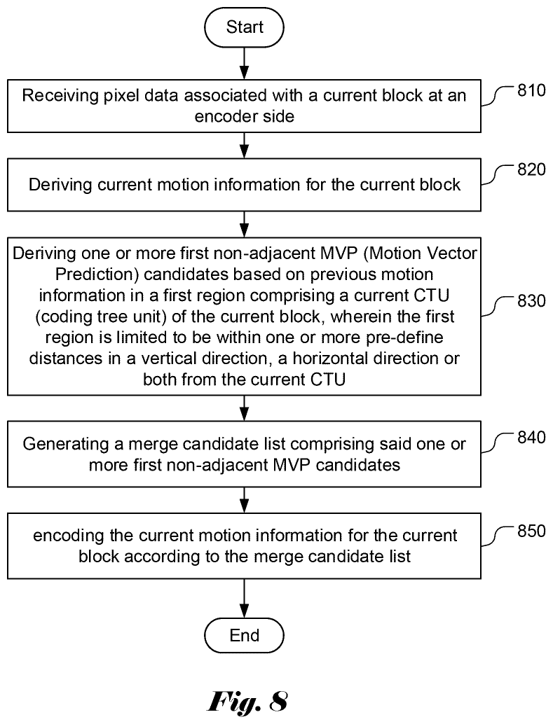

FIG. 7 illustrates a flowchart of an exemplary video decoding system that limits the region for deriving non-adjacent MVP candidates according to one embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, coded data associated with a current block to be decoded are received at a decoder side in step 710. One or more first non-adjacent MVP (Motion Vector Prediction) candidates are derived based on previous motion information in a first region comprising a current CTU (coding tree unit) of the current block in step 720, wherein the first region is limited to be within one or more pre-define distances in a vertical direction, a horizontal direction or both from the current CTU. A merge candidate list comprising said one or more first non-adjacent MVP candidates is generated in step 730. Current motion information is derived for the current block from the coded data according to the merge candidate list in step 740.

FIG. 8 illustrates a flowchart of an exemplary video encoding system that limits the region for deriving non-adjacent MVP candidates according to one embodiment of the present invention. According to this method, pixel data associated with a current block at an encoder side are received in step 810. Current motion information is derived for the current block in step 820. One or more first non-adjacent MVP (Motion Vector Prediction) candidates are derived based on previous motion information in a first region comprising a current CTU (coding tree unit) of the current block in step 830, wherein the first region is limited to be within one or more pre-define distances in a vertical direction, a horizontal direction or both from the current CTU. A merge candidate list comprising said one or more first non-adjacent MVP candidates is generated in step 840. The current motion information for the current block is encoded according to the merge candidate list in step 850.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video decoding, the method comprising:
receiving coded data associated with a current block to be decoded at a decoder side;
deriving one or more first non-adjacent MVP (Motion Vector Prediction) candidates based on previous motion information in a first region comprising a current CTU (coding tree unit) of the current block, wherein the first region is limited to be within one or more pre-define distances in a vertical direction, a horizontal direction or both from the current CTU;
generating a merge candidate list comprising said one or more first non-adjacent MVP candidates; and
deriving current motion information for the current block from the coded data according to the merge candidate list.

2. The method of claim 1, wherein the first region comprises a current CTU row of the current block or left M CTUs of the current block, and wherein M is a positive integer.

3. The method of claim 2, wherein the first region further comprises N above CTU rows, and wherein N is a positive integer.

4. The method of claim 2, wherein motion information for the current CTU row is stored in an N×N grid.

5. The method of claim 1, wherein one or more second non-adjacent MVP candidates at one or more to-be referenced positions in a second region outside the first region are selected and included in the merge candidate list, and wherein said one or more to-be referenced positions are mapped to one or more pre-defined positions.

6. The method of claim 5, wherein the first region comprises a current CTU row of the current block and above-first CTU row of the current block.

7. The method of claim 6, wherein the second region comprises an above-second CTU row and an above-third CTU row.

8. The method of claim 7, wherein a target pre-defined position associated with a corresponding to-be referenced position is located at one line above the above-first CTU row.

9. The method of claim 7, wherein a target pre-defined position associated with a corresponding to-be referenced position is located at a bottom line of respective CTU row associated with the corresponding to-be referenced position.

10. The method of claim 7, wherein a target pre-defined position associated with a corresponding to-be referenced position is located at a bottom line or a centre line of respective CTU row associated with the corresponding to-be referenced position, depending on the corresponding to-be referenced position.

11. The method of claim 7, wherein a target pre-defined position associated with a corresponding to-be referenced position is located at a bottom line of respective CTU row or one CTU row above the respective CTU row associated with the corresponding to-be referenced position, depending on the corresponding to-be referenced position.

12. The method of claim 7, wherein a target pre-defined position and a corresponding to-be referenced position are at a same horizontal position.

13. The method of claim 7, wherein motion information for the first region is stored in 4×4 grid and the motion information outside the first region is stored in 16×16 grid.

14. A method of video encoding, the method comprising:
receiving pixel data associated with a current block at an encoder side;
deriving current motion information for the current block;
deriving one or more first non-adjacent MVP (Motion Vector Prediction) candidates based on previous motion information in a first region comprising a current CTU (coding tree unit) of the current block, wherein the first region is limited to be within one or more pre-define distances in a vertical direction, a horizontal direction or both from the current CTU;
generating a merge candidate list comprising said one or more first non-adjacent MVP candidates; and
encoding the current motion information for the current block according to the merge candidate list.

15. An apparatus for video decoding, the apparatus comprising one or more electronics or processors arranged to:
receive coded data associated with a current block to be decoded at a decoder side;
derive one or more first non-adjacent MVP (Motion Vector Prediction) candidates based on previous motion information in a first region comprising a current CTU (coding tree unit) of the current block, wherein the first region is limited to be within one or more pre-define distances in a vertical direction, a horizontal direction or both from the current CTU;
generate a merge candidate list comprising said one or more first non-adjacent MVP candidates; and
derive current motion information for the current block from the coded data according to the merge candidate list.

16. An apparatus for video encoding, the apparatus comprising one or more electronics or processors arranged to:
receive pixel data associated with a current block at an encoder side;
derive current motion information for the current block;
deriving one or more first non-adjacent MVP (Motion Vector Prediction) candidates based on previous motion information in a first region comprising a current CTU (coding tree unit) of the current block, wherein the first region is limited to be within one or more pre-define distances in a vertical direction, a horizontal direction or both from the current CTU;
generate a merge candidate list comprising said one or more first non-adjacent MVP candidates; and
encode the current motion information for the current block according to the merge candidate list.
